(19) United States
(12) Patent Application Publication
(10) Pub. No.: US 2019/0227153 A1
(43) Pub. Date: Jul. 25, 2019

(54) ROBUST, DUAL LOOP CONTROL OF A DISTRIBUTED TRANSMIT ARRAY

(71) Applicant: THE CHARLES STARK DRAPER LABORATORY, INC., Cambridge, MA (US)

(72) Inventors: Kenneth Houston, Francestown, NH (US); Stanley R. Shanfield, Newton, MA (US); Robert D. Tingley, Ashland, MA (US)

(21) Appl. No.: 16/251,851

(22) Filed: Jan. 18, 2019

Related U.S. Application Data
(60) Provisional application No. 62/619,389, filed on Jan. 19, 2018.

(51) Int. Cl. G01S 7/524; G01H 9/00; G10K 11/34

(52) U.S. Cl. CPC G01S 7/524; G10K 11/341; G01H 9/002

(57) ABSTRACT

A method of forming a coherent acoustic beam in a marine environment includes directing each of a plurality of source nodes deployed in the marine environment to move in a respective stationary orbit, transmitting an acoustic source signal from each source node; operating a first control loop to adjust a position of each of the plurality of source nodes within the marine environment; and operating a second control loop to adjust characteristics of the acoustic source signals transmitted by each of the source nodes to form a coherent acoustic beam in the far field of a transmitting array formed by the plurality of source nodes. An acoustic beamforming system configured to operate in a marine environment is also provided.

### CROSS REFERENCE TO RELATED APPLICATION

This application claims the benefit under 35 U.S.C. § 119(e) of co-pending U.S. Provisional Application No. 62/619,389 filed on Jan. 19, 2018, which is herein incorporated by reference in its entirety for all purposes.

### BACKGROUND

Various techniques for coherent beamforming are known in the wireless radio frequency (RF) communications field. However, RF and other communications systems that perform coherent beamforming from distributed transmitters, such as for providing communication between base stations, for example, rely on feedback from the focal point. Therefore, these types of techniques and approaches cannot be used in applications where a signal is directed at a target that does not communicate with the source of the signal.

### SUMMARY OF THE INVENTION

Aspects and embodiments are directed to systems and methods of forming a coherent beam from a collection of distributed sources, particularly in marine environments.

According to one aspect of the present disclosure, a method of forming a coherent acoustic beam in a marine environment comprises directing each of a plurality of source nodes deployed in the marine environment to move in a respective stationary orbit; transmitting an acoustic source signal from each source node; operating a first control loop to adjust a position of each of the plurality of source nodes within the marine environment; and operating a second control loop to adjust characteristics of the acoustic source signals transmitted by each of the source nodes to form a coherent acoustic beam in the far field of a transmitting array formed by the plurality of source nodes.

In some embodiments, the method further comprises monitoring the acoustic source signals transmitted by the plurality of source nodes with a control node.

In some embodiments, directing each of the plurality of source nodes to move in a respective stationary orbit includes directing the plurality of source nodes to maintain a specified angular spacing relative to one another.

In some embodiments, operating the second control loop includes monitoring at least one of amplitude, phase, and frequency of each of the acoustic source signals.

In some embodiments, the method further comprises modeling at least a portion of the marine environment to provide a model of the marine environment, wherein operating the second control loop includes adjusting the characteristics of the acoustic source signals transmitted by each of the source nodes based on the model of the marine environment to form the coherent acoustic beam in the far field.

According to another aspect of the present disclosure, an acoustic beamforming system configured to operate in a marine environment comprises a transmit array deployed in the marine environment, the transmit array including a plurality of source nodes, each source node configured to transmit an acoustic source signal; and a control node in wireless communication with each of the plurality of source nodes, the control node being configured to monitor the acoustic source signals transmitted by the plurality of source nodes and to operate a dual-loop control process to control the plurality of source nodes such that a combination of the acoustic source signals forms a coherent acoustic beam in the far field of the transmit array, the control node being configured to operate a first control loop of the dual-loop control process to control the plurality of source nodes to adjust characteristics of the acoustic source signals, and the control node being configured to operate a second control loop of the dual-loop control process to control positions of the plurality of source nodes in the marine environment.

In some embodiments, the control node is configured to monitor at least one of amplitude, phase, and frequency of the acoustic source signals.

In some embodiments, in operating the second control loop, the control node is configured to direct the plurality of source nodes to maintain a specified angular spacing relative to one another.

In some embodiments, each of the plurality of source nodes moves in a respective stationary orbit.

In some embodiments, in operating the second control loop the control node is configured to control parameters of the stationary orbit of each respective source node, the parameters including orbital speed, orbital direction, and a location of a centerpoint of the respective stationary orbit.

In some embodiments, each source node includes an omnidirectional transmitting antenna to transmit the acoustic source signal.

According to another aspect of the present disclosure, a method of forming a coherent acoustic beam in a marine environment comprises creating a virtual ocean model of dynamic behavior of ocean water between a plurality of source nodes and a target focal point based on historical data of at least one of salinity of the ocean water, temperature of the ocean water, and total depth of the ocean water and updated measurements of temperature of the ocean water; determining an optimum amplitude, an optimal phase, and an optimal frequency of a respective signal to be transmitted by each source node by iteratively calculating characteristics of a received sound at the target focal point based on the virtual ocean model to obtain a coherently focused maximum amplitude signal in a region of the target focal point; adjusting at least one of an amplitude, a phase, and a frequency of the respective signal transmitted by at least one source node based on at least one of the determined optimum amplitude, the determined optimal phase, and the determined optimal frequency content for the respective source node; and adjusting at least one of the amplitude, the phase, and the frequency content of the respective signal transmitted by at least one source node to maintain the coherently focused maximum amplitude signal in the region of the target focal point in real time as a position of at least one source node changes.

In some embodiments, the updated measurements further include real time measurements of at least one of latitude of the source nodes and the target focal point, and longitude of the source nodes and the target focal point.

In some embodiments, iteratively calculating characteristics of the received sound comprises iteratively calculating at least one of frequency of the received sound, amplitude of the received sound, and coherence of the received sound.

In some embodiments, the method further comprises operating a control loop to adjust a position of each of the plurality of source nodes within the marine environment.

In some embodiments, operating the control loop to adjust the position of each of the plurality of source nodes further comprises directing each of the plurality of source nodes to move in a respective stationary orbit.

In some embodiments, directing each of the plurality of source nodes to move in a respective stationary orbit includes directing the plurality of source nodes to maintain a specified angular spacing relative to one another.

In some embodiments, the method further comprises adjusting at least one of the amplitude, the phase, and the frequency of a respective signal transmitted by a source node based on feedback from a device at the target focal point.

In some embodiments, the method further comprises monitoring the respective signals transmitted by the plurality of source nodes with a control node positioned at a location other than the target focal point.

According to another aspect of the present disclosure, a method of forming a coherent acoustic beam in a marine environment comprises creating a virtual ocean model of dynamic behavior of ocean water between a plurality of source nodes and a target focal point based on historical data of at least one of salinity of the ocean water, temperature of the ocean water, total depth of the ocean water, and updated measurements of temperature of the ocean water versus depth, latitude, and longitude; determining an optimum amplitude, an optimal phase, and an optimal frequency of a respective signal to be transmitted by each source node by iteratively calculating characteristics of a received sound at the target focal point based on the virtual ocean model to obtain a coherently focused maximum amplitude signal in a region of the target focal point; adjusting an amplitude, a phase, and a frequency of the respective signal transmitted by at least one source node based on the determined optimum amplitude, the determined optimal phase, and the determined optimal frequency for the respective source node; and adjusting the amplitude, the phase, and the frequency of the respective signal transmitted by at least one source node to maintain the coherently focused maximum amplitude signal in the region of the target focal point in real time as a position of at least one source node changes.

In some embodiments, the method further comprises adjusting the amplitude, the phase, and the frequency of a respective source node based on feedback from a device at the target focal point.

In some embodiments iteratively calculating characteristics of the received sound comprises iteratively calculating at least one of frequency of the received sound, amplitude of the received sound, and coherence of the received sound.

According to another aspect of the present disclosure, a method of forming a coherent acoustic beam in a marine environment comprises modeling at least a portion of the marine environment to provide a model of the marine environment; directing each of a plurality of source nodes deployed in the marine environment to move in a respective stationary orbit; transmitting an acoustic source signal from each source node; operating a first control loop to adjust a position of each of the plurality of source nodes within the marine environment; and operating a second control loop to adjust characteristics of the acoustic source signals transmitted by each of the source nodes based on the model of the marine environment to form a coherent acoustic beam in a far field of a transmitting array formed by the plurality of source nodes.

In some embodiments, modeling at least the portion of the marine environment includes modeling properties of a segment of the marine environment between at least one of the plurality of source nodes and a target focal point in the far field.

In some embodiments, modeling at least the portion of the marine environment includes modeling at least one of water depth, water salinity, water temperature, water density, and internal waves in the marine environment between at least one of the plurality of source nodes and a target focal point in the far field.

In some embodiments, modeling at least the portion of the marine environment includes modeling at least one of water depth, water salinity, water temperature, water density, and internal waves in the marine environment between each of the source nodes and a target focal point in the far field.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic diagram illustrating one example of a system for forming a coherent beam;

FIG. 2 is a block diagram illustrating a mathematical representation of the characterization of the acoustic signals transmitted from source nodes;

FIG. 3 is a block diagram illustrating another mathematical representation of the characterization of the acoustic signals transmitted from source nodes adjusted using the small angle approximation;

FIG. 4 is a simulation block diagram for an example of the system of FIG. 1;

FIG. 5 is a block diagram of one example of a source node system architecture;

FIG. 6 is a graph showing simulated transmit array beam patterns as a function of steering angle;

FIG. 7 is another graph showing simulated transmit array beam patterns as a function of steering angle;

FIG. 8 is another graph showing simulated transmit array beam patterns as a function of steering angle; and

FIG. 9 is another graph showing simulated transmit array beam patterns as a function of steering angle.

### DETAILED DESCRIPTION

The capability of forming a coherent beam from distributed sources as described herein is useful in a variety of underwater applications, such as maritime anti-submarine warfare and marine surveys, by enabling the surgical and flexible application of acoustic energy in a variety of important scenarios. However, conventional beamforming approaches are not applicable when communication with, or feedback from, the target at which the coherent beam is to be directed is not available. Aspects and embodiments provide a system and method for forming a coherent beam in the far field from a plurality of underwater source nodes. As discussed in detail below, the method and system can direct a coherent beam in the far field to a target (such as a receiving array) without communicating with the target, and in such instances may be referred to as open loop with respect to the target. By leveraging the coordinated efforts of several small autonomous platforms, systems and methods disclosed herein offer unprecedented control over the angular power spectrum, rapid system deployment, and responsive operations.

Unlike the typical environments, such as air-based environments, in which conventional RF communications systems perform distributed transmit beamforming, the underwater propagation environment is characterized as a dispersive media that is both unknown and randomly time-variant. Thus, forward-predicting transmission with sufficient phase/delay purity to calculate destination focus, especially at the top of the medium frequency (MF) band (or at a frequency value, such as 3 kHz, within the MF band), is unlikely given the present fidelity and resolution of existing bathymetry, real-time ocean data assimilation products, and current propagation tools. Moreover, additional effects such as internal waves of the environment are also not adequately modeled. Further, there is presently only imprecise knowledge of a time-variant array manifold, which prevents calculation of digital array corrections using feedforward techniques. Moreover, the time-variant nature of the problem means that even if calibrations or corrections could be calculated they would likely be stale by the time they are instantiated at the source nodes.

There is no existing geolocation technology capable of performing system calibration. Present state of the art ultra-short baseline (USBL) positioning systems offer meter-class relative accuracy for favorable geometries (dependent on range rather than crossrange) for fields spanning a kilometer or so. This performance is simply inadequate in the MF band of operation, particularly for larger and multiple angle spreads (e.g., 5 degrees or greater). In addition, commercially available USBL transponders add significantly to system power and weight specifications.

As discussed above, most distributed RF beamforming systems address the foregoing issues through the use of destination-point feedback tightly integrated into the network protocol. However, in certain applications this approach fails for at least two reasons. First, in certain applications the channel propagation delay exceeds the coherence time, and therefore any characterization derived over the full length is likely to be stale by the time that it is applied as a correction. Second, in many important applications the destination is inaccessible as a point from which to derive feedback.

Aspects and embodiments are directed to a system that accomplishes coherent beamforming in the far field using a plurality of distributed source nodes, that together form a distributed transmit array, and a control node. Each of the nodes can be an autonomous underwater vehicle (AUV). Aspects and embodiments further provide a method of robust, dual-loop control of the distributed transmit array. The transmit array produces a signal that is coherent in the far field, and that is composed of source signals from each of the source nodes. Unlike conventional approaches using a feedforward architecture as discussed above, embodiments of the system and method disclosed herein advantageously do not require precise geolocation of the source nodes of the distributed transmit array, and do not require precise knowledge of the characteristics of the water column between the source nodes and the target.

Nor do embodiments of the system require feedback from the target. Embodiments of the system can operate as an open loop system with respect to the target, in which the system relies either purely on a “virtual ocean” model of dynamic behavior of ocean water, or on a combination of both a “virtual ocean” model and feedback from devices located away from the target focal point. Embodiments of the system adjust the signals that are transmitted by the source nodes (such as broadcasting transducers) to account for characteristics of the ocean water column between the source nodes and the target by modeling the ocean water column, as discussed further below.

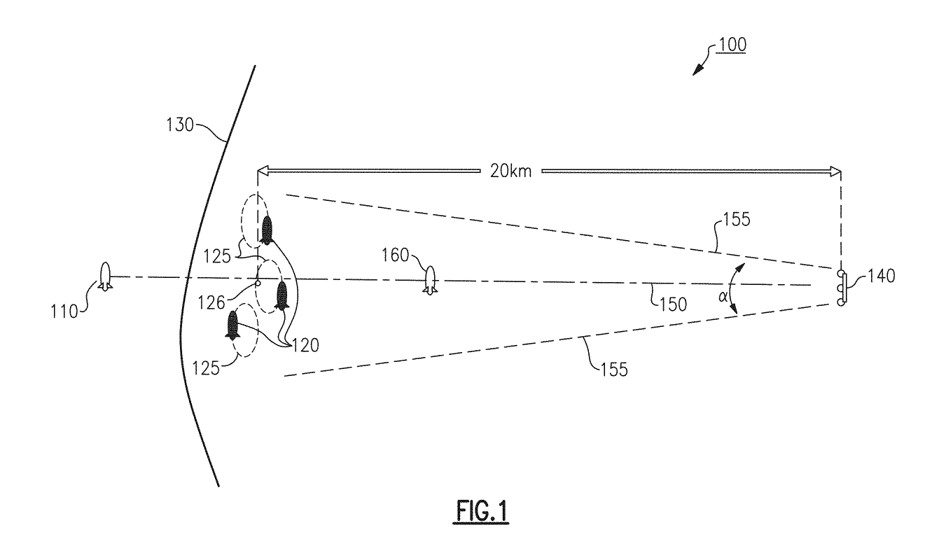

Referring to FIG. 1, the system 100 includes a control node 110 and a distributed transmit array including a plurality of source nodes 120 that are each in communication with the control node 110. The control node 110 and the plurality of source nodes 120 may be deployed in a body of water, such as an ocean or lake, for example. The source nodes 120 are in wireless communication with the control node 110 and can receive commands from the control node 110, as discussed further below. Each source node 120 transmits a source signal. In one example the source signals are acoustic signals. In one example the source signals are acoustic signals having a frequency of 3 kHz. In some embodiments, source signals are acoustic signals having a frequency in the range of about 300 Hz to about 3 kHz. Below about 300 Hz, the transducers of the source nodes would need to be much larger than desirable for most practical applications of the embodiments of the present disclosure. Above about 3 kHz, the signal will likely not travel far enough through the water for most practical applications of the embodiments of the present disclosure. Each source node 120 can include an omnidirectional transmit antenna such that the source signals can be transmitted omnidirectionally.

The source nodes 120 can be deployed in the body of water in a “drop-off” location, identified by boundary line 130, from a ship or other watercraft or from an aircraft. As discussed in detail below, the transmit array formed by the plurality of source nodes 120 is configured to produce an acoustic signal having a coherent wavefront in the far field and particularly at the location of a target. In the diagram of FIG. 1, this target is represented by a test array 140, which may be an array at a target focal point, for example. The test array 140 is located some distance away from the plurality of source nodes 120 along an average vector 150. In the example illustrated in FIG. 1, this distance is approximately 20 kilometers; however, the target may be located at any distance from the plurality of source nodes provided that it is in the far field of the combined signal generated by the transmit array. In certain examples the plurality of source nodes can be deployed at roughly the location at which they are to be operated; however, in other examples, the source nodes can be deployed at a different location and can be directed (e.g., by the control node 110) to travel to the desired location. In one example the control node 110 can be deployed along with the source nodes 120. In other examples, the control node 110 can be deployed at a different time.

According to one embodiment, the source nodes 120 are directed to nominal locations within the ensonification volume, where they enter into stationary orbits (indicated by dashed ovals 125). The nominal locations can be based on knowledge or an estimate of the location of the target 140. The source nodes 120 can be instructed to arrange themselves such that a rough center 126 of the transmit array formed by the plurality of source nodes falls along the vector 150. The control node 110 can be positioned on the vector 150 as well. In one example the source nodes 120 are located within a volume (bounded by dashed lines 155) defined by an angle a about the centerline vector 150. In some examples a is approximately 5°. In the example shown in FIG. 1, the system includes three source nodes 120, which may be spaced apart by 2° between a first one of the source nodes 120 and a second one of the source nodes 120, and spaced apart by 2° between the second one of the source nodes 120 and a third one of the source nodes 120. In some examples, five source nodes 120 are provided and are located within an angle a of 5° about the vector 150. However, in other examples any number of source nodes 120 can be included. The orbital paths 125 of the source nodes 120 can enhance the stability of the source nodes within the body of water. In some embodiments, a center point of each orbital path is stationary (at a fixed location) within the body of water. In other embodiments, the center point of each orbital path is dynamic, and moves over time.

Once the transmit array is set up (i.e., the source nodes 120 and the control node 110 are in their desired positions), the control node 110 may direct the source nodes 120 into an active mode (in which the source nodes transmit acoustic signals) and may begin to receive the acoustic transmissions from the source nodes 120. As discussed above, the control node 110 can implement a dual-loop control process to control the source nodes 120 such that a combined signal produced by the transmit array is coherent in the far field. According to one embodiment, based upon demodulating the source signals, and correction with predictive acoustic models, the control node 110 feeds compensation instructions back (fast loop) to the source nodes 120 such that a fully-coherent wavefront is generated in the frame of reference of the target 140. The control node 110 also feeds back navigation instructions (slow loop) maintaining source node positions for proper ensonification, angle spread and collision avoidance. In embodiments in which the source nodes 120 transmit their acoustic source signals omnidirectionally, provided that the control node 110 is positioned in the far field of the signal from the transmit array, the control node receives a wavefront that is essentially very similar to that received at the target 140. Accordingly, the control node 110 can provide correction instructions to the source nodes 120 based on the acoustic signals it receives from the source nodes 120. However, in certain embodiments, the system 100 can also include an in situ monitoring node 160 positioned between the source nodes 120 and the target 140 to receive the acoustic signals. The monitoring node 160 can be in communication with the control node 110 to provide the control node with data or measurements of the acoustic signals, based on which the control node 110 can provide instructions to the source nodes 120. In certain embodiments, the control node 110 is configured to run software and fully implement the dual-loop control of the source nodes 120. In other embodiments, some or all of the processing can be accomplished by a remote controller (e.g., positioned on a ship, aircraft, satellite, or remote ground station) that is in communication with the control node 110.

In some embodiments, the system does not rely on a monitoring node, and instead relies entirely on a predictive acoustic model of the media between the source nodes and a target focal point in the far field. In some embodiments, the predictive acoustic model is a virtual ocean model. In some embodiments, the virtual ocean model is a model of properties of a segment of the marine environment between one or more source nodes and a target focal point in the far field. In some embodiments, modeling the marine environment includes modeling water depth, water salinity, water temperature, water density, and/or internal waves in the marine environment between each of the source nodes and a target focal point in the far field. In some embodiments, the systems and methods of the present disclosure update the model of the marine environment in real time. In some embodiments, the model of the marine environment may be based on historical data of properties of the marine environment, real time measurements of properties of the marine environment, or a combination thereof.

Some embodiments of the present disclosure include a feedback loop that is used to adjust the amplitude and phase of the transmitted signal from each source node and obtain a coherently focused maximum amplitude in the region of a “focal point” at the target location. In longer distance cases, or in shallow waters, however, a fixed feedback algorithm will be unable to achieve near optimum combinations of phase and amplitude of the coherent signal in the far field, as the behavior of the arriving signal at a desired focal point depends non-linearly and non-monotonically on the phase and amplitude of the respective signal from each source node. This situation occurs because the ocean is not an isotropic medium for sound waves, and variations in salinity, temperature, total depth of the water and other physical characteristics result in variations in sound propagation speed, leading to sound diffraction and frequency dispersion. This situation is particularly true over longer transmission distances (such as between about 10 kilometers to about 50 kilometers), or where the ocean is shallow, and reflections are especially important. In some embodiments, the transmission distance is about 10 kilometers, about 20 kilometers, about 30 kilometers, about 40 kilometers, or about 50 kilometers.

The signals propagate from the source nodes in a “multi-path” manner, in which each signal from the respective source nodes travels a different distance to the target focal point and passes along different paths through the water relative to the signals from the other source nodes. To address this varying multi-path situation, certain embodiments of the array focusing methods of the present disclosure rely on a virtual ocean model. Using prior knowledge of the ocean depth versus latitude and longitude, and with some availability of updated measurements of local ocean temperature versus depth, latitude, and longitude, an accurate sound speed model of the ocean propagation medium can be generated using appropriate optimization methods. For example, a deep learning neural network algorithm, along with the use of historical and (when available) real time measurements can be used to converge to a “best” virtual ocean model. In situations where a virtual ocean model can be deduced, receivers are no longer necessary in the focal region where sound amplitude is maximized However, having feedback receivers can be used to further advantage, if it is available. Using the virtual ocean model without feedback from receivers in the focal region may be of critical advantage if access to the focal region is restricted, or if receivers are only nearby the focus region. Once an optimum virtual ocean model is established, the optimum amplitude, phase and frequency content of each source node is similarly determined by iteratively calculating the characteristics of the received sound through the virtual ocean model into the desired focal region. The system can adjust the amplitude, phase, and/or frequency of the respective signals transmitted by the source nodes to obtain a coherently focused maximum amplitude signal in a region of the target focal point. As the position of the source node changes, the virtual ocean model calculation can adjust amplitude, phase, and/or frequency content of signals transmitted by one or more source nodes to maintain the same focused region.

In some embodiments, a method of forming a coherent acoustic beam in a marine environment includes creating a virtual ocean model of dynamic behavior of ocean water between a plurality of source nodes and a target focal point based on historical data, and updated measurements. The method also includes determining an optimum amplitude, an optimal phase, and an optimal frequency of a respective signal to be transmitted by each source node by iteratively calculating characteristics of a received sound at the target focal point based on the virtual ocean model to obtain a coherently focused maximum amplitude signal in a region of the target focal point. The method also includes adjusting an amplitude, a phase, and/or a frequency of the respective signal transmitted by at least one source node based on the determined optimum amplitude, the determined optimal phase, and/or the determined optimal frequency content for the respective source node. In some embodiments, the method further includes adjusting the amplitude, the phase, and/or the frequency content of the respective signal transmitted by at least one source node to maintain the coherently focused maximum amplitude signal in the region of the target focal point in real time as a position of at least one source node changes.

In some embodiments, the historical data includes historical data of least one of salinity of the ocean water, temperature of the ocean water, and/or total depth of the ocean water in the region of the ocean between the source nodes and the target focal point. In some embodiments, the updated measurements include real time measurements of temperature of the ocean water versus depth, latitude of the source nodes and the target focal point, and/or longitude of the source nodes and the target focal point.

Embodiments of the system 100 enable a mobile, reconfigurable, re-taskable multi-mission acoustic system. In addition, embodiments of the system 100 provide a much larger effective baseline than would a uniformly-spaced array of similar element count and complexity, which can be a very useful feature in certain applications.

In addition to a longer baseline, which may be up to 50 kilometers in some embodiments, the focusing can be accomplished in regions of the ocean where the feedback system alone would not operate effectively, for example in littoral regions where the depth is less than 100 meters, or where the depth is changing significantly over the region of propagation.

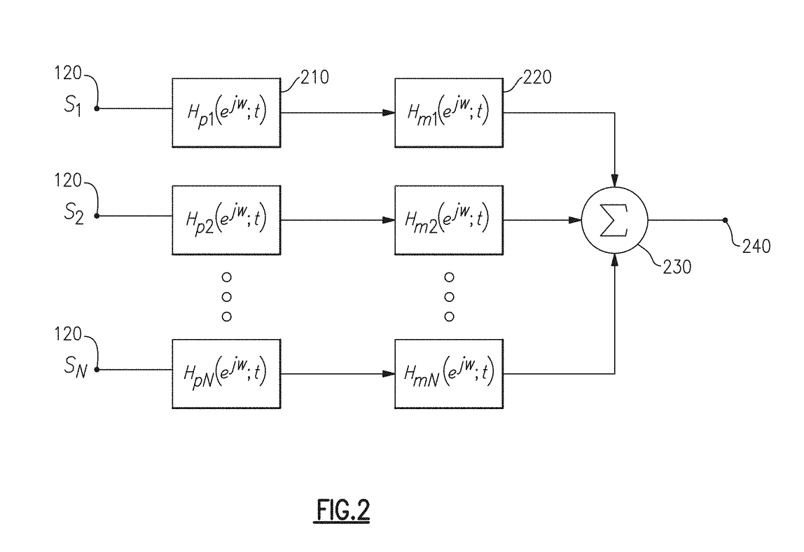

The energy generated by each source node 120 experiences a unique slowly time-variant propagation function, characterized by attenuation, Doppler shift, time delay and dispersion. Although a complete estimation of this propagation function would be a complex and difficult problem, as discussed above, in certain embodiments, coverage is limited to roughly a five degree angle power spectrum, allowing use of the small angle approximation to simplify the analysis. Referring to FIG. 2, the transmit array includes N source nodes 120, designated S₁, S₂, . . . , S_{N}, each transmitting an acoustic source signal. The propagation functions for these acoustic source signals are each decomposed into a first portion 210 corresponding to an isotropic spreading environment (Hₚₙ), and a media function (Hₘₙ) 220 representing all the perturbation thereto, such as close-field bathymetry, internal waves, a dynamic boundary at the sea surface and a range dependent sound speed profile (RDSSP). The acoustic source signals, modified by the propagation and media functions, are superposed in the far field, represented in FIG. 2 by the summation block 230. The combined acoustic signal, referred to as the field point response 240 of the transmit array, is received at the target 140.

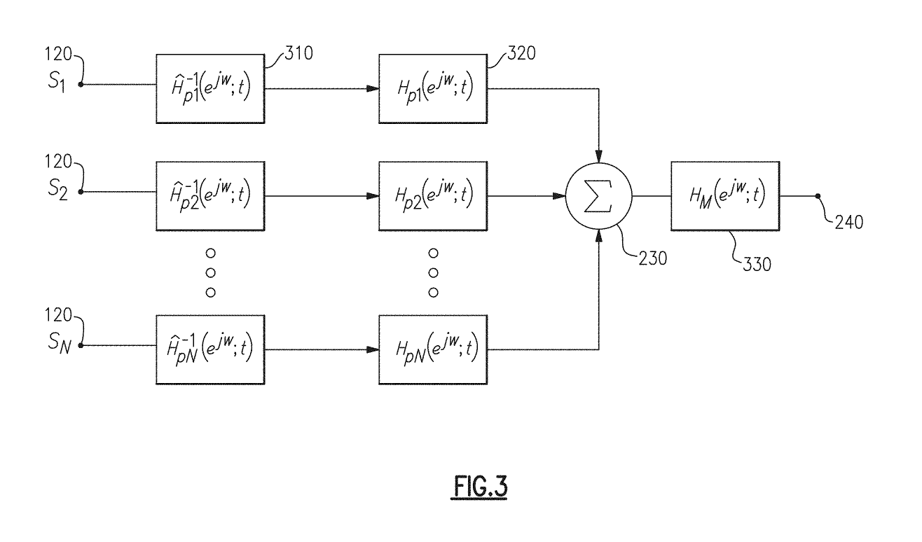

Many of the perturbations represented by the media functions 220 evolve too rapidly for accurate characterization of the perturbations. Thus, compensation to within a few degrees of the desired phase at the receiving point may be impractical. However, using the small angle approximation, for the geometry shown in FIG. 1, the rays representing the acoustic source signals are nearly parallel during these perturbations, and thus experience virtually the same media effects. As a result, the media functions can be factored out as a common element, eliminating their address for the purposes of steering. Compensating for the array manifold now provides for coherent energy delivery to the field point, as depicted in FIG. 3.

Referring to FIG. 3, with the small angle approximation as discussed above, propagation of the acoustic source signals from each source node 120 (Sₙ), is now characterized by a steering function 310 and a propagation function 320. The acoustic source signals are superposed in the far field, represented by the summation block 230, as discussed above, and the combined signal is characterized by a common media function 330. This common media function 330 may be substituted with a virtual ocean model, such as any embodiment of a virtual model of the present disclosure.

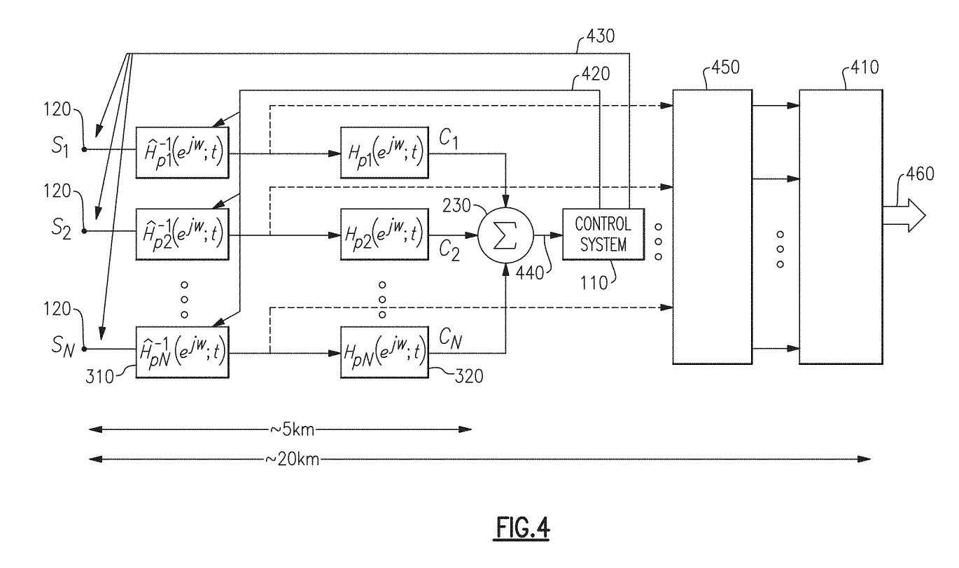

Referring to FIG. 4 there is illustrated a block diagram of a simulation of operation of an embodiment of the system 100 shown in FIG. 1. The control node 110 includes at least one processor. As discussed above, the control node 110 implements a dual-loop (a fast loop 420 and a slow loop 430) control process to control the source nodes, in terms of the their positions and the characteristics of the acoustic signals they generate, such that the combined acoustic signal (field point response 240) is coherent in the far field and at the target 140. An example of this process is described with reference to FIG. 4. In FIG. 4, the target 140 is represented by a test array 410.

According to one embodiment, during operation the control node 110 continuously measures the acoustic source signals produced from each of the individual source nodes 120, including amplitude, relative phase, frequency offset etc., as well as tracking source node trajectories. The acoustic source signals from the source nodes 120 are modified by their respective steering functions 310 and propagation functions 320, and the summed aggregate 440 is fed to the control node 110. In the fast control loop 420, the control node 110 feeds back corrections to the elemental steering functions 310, driving their aggregate 440 toward coherence in the far field. For relatively benign environments and centroidal operation, this optimal point also ensures coherence at the test array 410. In more complex environments, beam control feedback is perturbed in the fast control loop 420 by forward predicting from the control node 110 to the test array 410.

The propagation functions 320, also referred to as control observation functions in FIG. 4, are slowly time-varying functions that characterize the propagation or transmission of the acoustic source signals from the source nodes 120 to the control node 110. In the simulation corresponding to FIG. 4, these functions 320 are modeled with a 1 second delay and less than 1 Hz FD at a frequency of 1500 Hz. The simulation model also assumes approximately a 5 kilometers separation between the source nodes 120 and the control node 110. The steering functions 310 are slowly time-varying compensation functions that “undo” the propagation functions 320 in phase. An additional propagation function block 450 models the properties of the body of water in which the source nodes 120 and the target 140 are located. This additional propagation function block 450 represents slowly time-varying functions that characterize the propagation or transmission of the acoustic source signals from the source nodes 120 to the test array 410. The simulation model of FIG. 4 assumes approximately a 20 kilometers separation between the source nodes 120 and the test array 410. The output 460 of the model is the angular power spectrum of the aggregate 440 of the acoustic source signal.

In certain examples, a desired angular power spectrum output 460 may depend on the type of receiving array 410. The characteristics of the acoustic source signals (such as the frequency content of each signal, the amplitude of each signal, and other characteristics) and the geometric distribution of the source nodes 120 can be changed to alter the angular power spectrum.

Still referring to FIG. 4, the control node 110 is also configured to operate the slow control loop 430 to determine or control the positions of each of the source nodes 120. In the slow control loop 430, navigation instructions are fed back to the source nodes 120, allowing station-keeping during tides or other effects in the marine environment to ensure maintenance of the desired angular power spectrum 460. The navigation control signals sent to the source nodes 120 from the control node 110 can be based on the monitoring of the acoustic source signals, as shown in FIG. 4. In one example, the control node 110 transmits coordinates or other information specifying a desired position of a respective source node 120 to the source node, which then adjusts its flight path. In some embodiments, the instructions provided by the control node 110 can direct the source node 120 to alter its orbital path 125 such that the respective source node orbits about the respective desired position. In some examples, the source nodes 120 travel to within about 50 meters to about 100 meters of the respective desired positions provided by the control node 110. In some examples the navigation instructions provided to the source nodes 120 from the control node 110 can specify absolute geographic positions; in other examples, the source nodes 120 can be instructed to move a specified distance in a certain direction from their current positions.

FIG. 5 is a block diagram of one example of the system architecture of a source node 120, including flight control functionality and acoustic signal processing. The source node 120 includes a mission computer 505 that directs or controls overall functionality of the source node 120. In one example, command and control functions (C2, shown in FIG. 5) and tasking are managed by the mission computer 505 in collaboration with the control node 110, via an acoustic data link using an acoustic modem 510. The source node 120 implements a flight control loop to assume and maintain flight assignments. Accordingly, the source node 120 includes flight instruments 515 and a flight computer 520. The flight computer 520 is in communication with the mission computer 505 to receive flight commands, such as flight parameters (e.g., position, size and direction of orbital flight path, speed, etc.) and navigation corrections as may be provided by the control node 110 during operation of the slow control loop 430 discussed above. The flight instruments 515 can include one or more sensors, such as an accelerometer, depth meter, gyroscope, and other instruments, that can provide information about the source node's flight parameters to the flight computer 520. The source node 120 further includes flight controls 525 and a propulsion system 530 that can be controlled by the flight computer 520 to navigate the source node 120 in the body of water in which it is deployed.

The source node 120 further includes components to implement acoustic signal processing and to generate the acoustic source signals. Thus, still referring to FIG. 5, the source node 120 includes at least one processor 535 capable of performing complex baseband waveform processing. The at least one processor 535 receives acoustic waveform processing commands from the mission computer 505. The at least one processor is coupled to a transducer power amplifier 540 for generating the acoustic source signals. In certain embodiments, the acoustic signal processing loop can operate in either a feedforward or feedback mode, and the source node 120 includes a mode switch 545 to select the mode of operation. In the feedback mode, the at least one processor 535 receives acoustic signals from its environment via a hydrophone 550. In the feedforward mode, the at least one processor 535 is connected to a waveform generator 555 and a coding/preprocessing unit 560. In certain embodiments, the source node 120 incorporates simultaneous transmit and receive technology, allowing a much broader and more effective range of signal processing effects to be incorporated within the feedback loop.

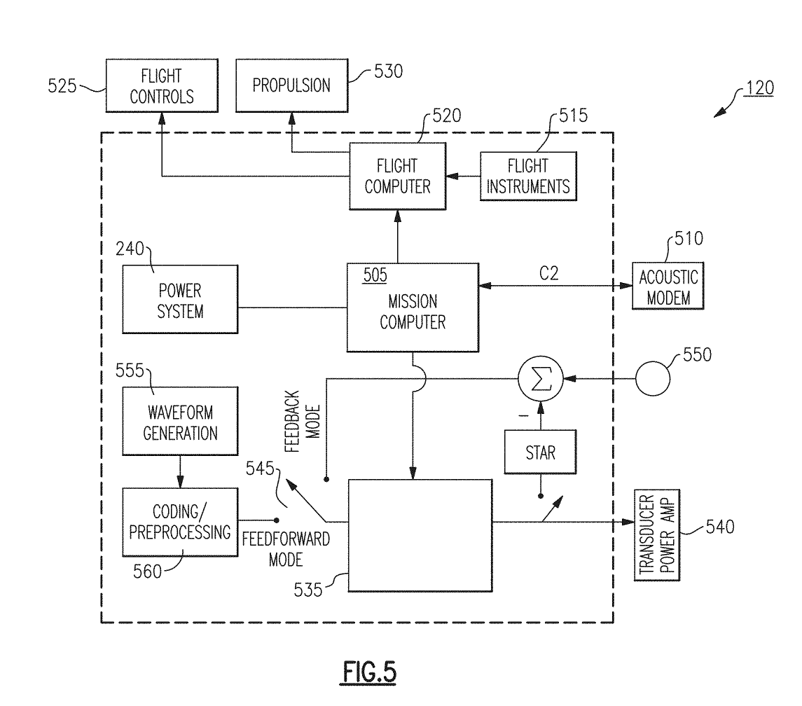

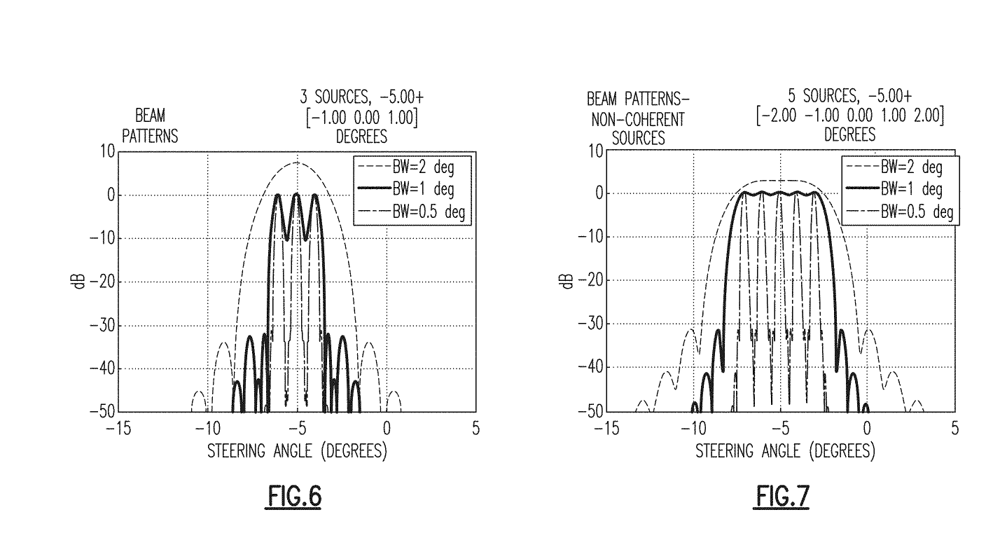

FIGS. 6-9 are graphs showing simulated beam patterns for different numbers of source nodes 120. The number of source nodes 120 needed to achieve a desired angular power spectrum 460 may vary. For the simulation, the source nodes 120 represent delta functions (impulses) in an angular power source distribution, which when convolved with a spatial filter generate a perceived angular power spectrum as viewed from the perspective of the test array 410. The number of source nodes 120 required to generate a perceived uniform illumination over an angular sector is a direct function of the resolution of the receiving array 410. For the perceived angular power spectrum 460 to be uniform, the spacing of the source nodes 120 needs to be roughly the same as the resolution of the receiving array. For example, a transmit array of five source nodes 120 at 1 degree spacing produces a flat or rounded beam pattern for a line test array 410 down to 0.75 degree resolution. For finer resolution, notches appear between the sources, as shown in FIGS. 6, 7, and 9, for example. The required spacing of the source nodes 120 determines the number of source nodes needed to cover a desired angular sector. For example, with 1 degree spacing between source nodes, 5 coherent sources are needed to illuminate a 5 degree sector. In the simulated examples, the amplitude of the aggregate acoustic signal received at the test array 410 corresponds to the single-source amplitude (0 dB in the plots) when the array resolution is 75% of the source spacing, and increases for lower resolution (multiple sources received within a beam). Therefore, 10 log N gain in the effective received level, where N is the number of sources, may not be typically achieved because beam energy is spread over an angular sector.

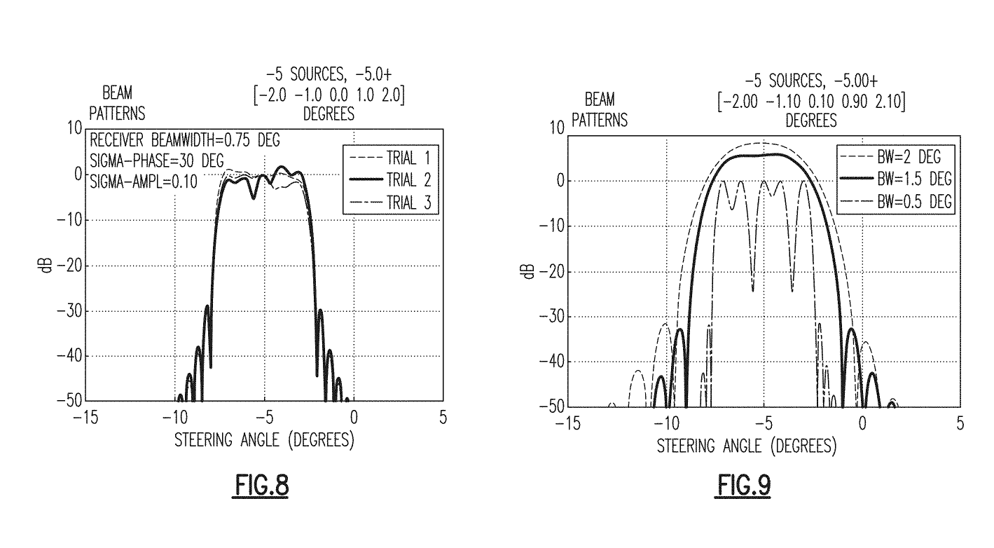

Attempts to achieve coherence in the acoustic signals at the target 140 are of course subject to errors in the amplitude or phase of the acoustic source signals and in the positions of the source nodes 120. From Monte Carlo runs, shown in FIG. 8, standard deviations on the order of 10% in amplitude and 30° in phase (each source, normally distributed) can be tolerated as a relatively uniform beam pattern is still achieved. At greater levels of error, a significant degradation in angular uniformity may be observed. In addition, non-uniform source node positioning may degrade the beam patterns.

Thus, aspects and embodiments provide a system and method capable of producing a coherent acoustic beam at a distant target without requiring feedback or transmissions from the target. As discussed above, this can be useful in a variety of military and commercial applications. The system can be configured to implement a robust dual-loop control process to achieve a high level of beam coherence at the target even in challenging marine environments.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. It is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A method of forming a coherent acoustic beam in a marine environment, the method comprising:
directing each of a plurality of source nodes deployed in the marine environment to move in a respective stationary orbit;
transmitting an acoustic source signal from each source node;
operating a first control loop to adjust a position of each of the plurality of source nodes within the marine environment; and
operating a second control loop to adjust characteristics of the acoustic source signals transmitted by each of the source nodes to form a coherent acoustic beam in the far field of a transmitting array formed by the plurality of source nodes.

2. The method of claim 1 further comprising monitoring the acoustic source signals transmitted by the plurality of source nodes with a control node.

3. The method of claim 1 wherein directing each of the plurality of source nodes to move in a respective stationary orbit includes directing the plurality of source nodes to maintain a specified angular spacing relative to one another.

4. The method of claim 1 wherein operating the second control loop includes monitoring at least one of amplitude, phase, and frequency of each of the acoustic source signals.

5. The method of claim 1 further comprising:
modeling at least a portion of the marine environment to provide a model of the marine environment, and
wherein operating the second control loop includes adjusting the characteristics of the acoustic source signals transmitted by each of the source nodes based on the model of the marine environment to form the coherent acoustic beam in the far field.

6. An acoustic beamforming system configured to operate in a marine environment, the system comprising:
a transmit array deployed in the marine environment, the transmit array including a plurality of source nodes, each source node configured to transmit an acoustic source signal; and
a control node in wireless communication with each of the plurality of source nodes, the control node being configured to monitor the acoustic source signals transmitted by the plurality of source nodes and to operate a dual-loop control process to control the plurality of source nodes such that a combination of the acoustic source signals forms a coherent acoustic beam in the far field of the transmit array, the control node being configured to operate a first control loop of the dual-loop control process to control the plurality of source nodes to adjust characteristics of the acoustic source signals, and the control node being configured to operate a second control loop of the dual-loop control process to control positions of the plurality of source nodes in the marine environment.

7. The acoustic beamforming system of claim 6 wherein the control node is configured to monitor at least one of amplitude, phase, and frequency of the acoustic source signals.

8. The acoustic beamforming system of claim 6 wherein in operating the second control loop, the control node is configured to direct the plurality of source nodes to maintain a specified angular spacing relative to one another.

9. The acoustic beamforming system of claim 6 wherein each of the plurality of source nodes moves in a respective stationary orbit.

10. The acoustic beamforming system of claim 9 wherein in operating the second control loop the control node is configured to control parameters of the stationary orbit of each respective source node, the parameters including orbital speed, orbital direction, and a location of a centerpoint of the respective stationary orbit.

11. The acoustic beamforming system of claim 6 wherein each source node includes an omnidirectional transmitting antenna to transmit the acoustic source signal.

12. A method of forming a coherent acoustic beam in a marine environment, the method comprising:
creating a virtual ocean model of dynamic behavior of ocean water between a plurality of source nodes and a target focal point based on historical data of at least one of salinity of the ocean water, temperature of the ocean water, and total depth of the ocean water and updated measurements of temperature of the ocean water;
determining an optimum amplitude, an optimal phase, and an optimal frequency of a respective signal to be transmitted by each source node by iteratively calculating characteristics of a received sound at the target focal point based on the virtual ocean model to obtain a coherently focused maximum amplitude signal in a region of the target focal point;
adjusting at least one of an amplitude, a phase, and a frequency of the respective signal transmitted by at least one source node based on at least one of the determined optimum amplitude, the determined optimal phase, and the determined optimal frequency content for the respective source node; and
adjusting at least one of the amplitude, the phase, and the frequency content of the respective signal transmitted by at least one source node to maintain the coherently focused maximum amplitude signal in the region of the target focal point in real time as a position of at least one source node changes.

13. The method of claim 12, wherein the updated measurements further include real time measurements of at least one of:
latitude of the source nodes and the target focal point, and
longitude of the source nodes and the target focal point.

14. The method of claim 13, wherein iteratively calculating characteristics of the received sound comprises iteratively calculating at least one of frequency of the received sound, amplitude of the received sound, and coherence of the received sound.

15. The method of claim 14, further comprising operating a control loop to adjust a position of each of the plurality of source nodes within the marine environment.

16. The method of claim 15, wherein operating the control loop to adjust the position of each of the plurality of source nodes further comprises directing each of the plurality of source nodes to move in a respective stationary orbit.

17. The method of claim 16, wherein directing each of the plurality of source nodes to move in a respective stationary orbit includes directing the plurality of source nodes to maintain a specified angular spacing relative to one another.

18. The method of claim 12, further comprising adjusting at least one of the amplitude, the phase, and the frequency of a respective signal transmitted by a source node based on feedback from a device at the target focal point.

19. The method of claim 12 further comprising monitoring the respective signals transmitted by the plurality of source nodes with a control node positioned at a location other than the target focal point.
